(19) United States
(12) Patent Application Publication
(10) Pub. No.: US 2024/0400023 A1
(43) Pub. Date: Dec. 5, 2024

(54) Trailer Control Module for a Brake Device, and Parking Brake Device

(71) Applicant: KNORR-BREMSE Systeme fuer Nutzfahrzeuge GmbH, Muenchen (DE)

(72) Inventors: Fabian GRIESSER, Muenchen (DE); Christian STEINGRUBER, Grossweil (DE)

(21) Appl. No.: 18/701,657

(22) PCT Filed: Oct. 14, 2022
(86) PCT No.: PCT/EP2022/078648

§ 371 Date: Apr. 16, 2024

(30) Foreign Application Priority Data
Oct. 16, 2021 (DE) 10 2021 126 891.5
Jan. 21, 2022 (DE) 10 2022 101 439.8

(51) Int. Cl. B60T 13/68; B60T 13/36

(52) U.S. Cl. CPC B60T 13/683; B60T 13/36; B60T 2270/402

(57) ABSTRACT

A trailer control module for a brake device, more particularly an electronic parking brake device, for a commercial vehicle, includes at least one control piston and at least one housing, in which the control piston is accommodated. The housing has at least one control connection point and at least one feedback connection point for controlling the control piston. The housing also has at least one supply connection point, which is connected to at least one supply line for supplying pressure fluid to the trailer control module. The control piston can be controlled bistably by the control connection point and by the feedback connection point. A parking brake device, more particularly an electronic parking brake device, for a vehicle, includes at least one such trailer control module.

### BACKGROUND AND SUMMARY

The present invention relates to a trailer control module for a brake device, in particular an electronic parking brake device, for a vehicle, in particular a commercial vehicle, having at least one control piston; and having at least one housing in which the control piston is accommodated.

The present invention relates further to a parking brake device, in particular an electronic parking brake device, for a vehicle, in particular a commercial vehicle, having at least one trailer control module as described above. In addition, the present invention relates to a commercial vehicle, in particular having at least one towing vehicle and having at least one trailer, having at least one parking brake device and having at least one trailer control module as described above.

Parking brake devices and associated trailer control modules for vehicles and in particular for commercial vehicles are already known from the prior art. In reference to commercial vehicles, braking systems with compressed air as the pressurized fluid are used, by means of which braking systems the spring brake cylinder of a commercial vehicle, but also the brakes of a trailer, can be operated.

DE 10 2015 107 125 A1, for example, discloses an apparatus for controlling a braking system for a commercial vehicle, having a parking brake control valve for providing a parking brake function for the commercial vehicle and a trailer control valve for providing a holding brake function and a function of electric braking for the trailer, wherein the trailer control valve has a parking brake piston which is movably arranged so as to control, in dependence on a vent state of a fourth trailer control valve port, venting of a second trailer control valve port by way of the first trailer control valve port in order to provide the holding brake function and the function of electric braking.

In addition, DE 10 2016 003 034 A1 discloses a vehicle, in particular a commercial vehicle, having an electronic parking brake which has at least one electropneumatic component for actuating the parking brake and a control device for activating at least one such electropneumatic component. It is here fundamental to the invention that at least one such electropneumatic component and/or the control device is/are integrated at least in part in a component other than a compressed air conditioning unit.

The trailer control modules from the prior art always require a signal from the parking brake device, which signal switches the trailer control module (also called the trailer control valve) into the driving or parked state and ensures that this state does not change unintentionally. Moreover, in the prior art, owing to the rigid functional coupling of the parking brake device and the trailer control module, the parking brake of the trailer cannot be activated independently of the parking brake of the towing vehicle.

There are additionally various parking strategies (trailer is braked or unbraked) which are defined by the design of the trailer control module. Consequently, a pneumatic parking brake is always necessary in the towing vehicle for switching the parked or driving state of the trailer, with the result that the switching arrangement for the parking brake and the trailer control module is complex, expensive and requires a large amount of installation space.

Further problems arise due to the line length from the parking brake device to the trailer control valve in different types of vehicle, which line length can vary so that the volume of the control line for the parking brake device is subject to fluctuations. It is possible, for example, for a small volume to be present in the control line, which results in a rapid pressure build-up and pressure drop in the control line to the trailer control module. If there is a large volume in the control line, however, the pressure build-up and pressure drop in the control line are slower or more sluggish. Consequently, the regulating behavior of the electronic parking brake device is complex and difficult to coordinate in conjunction with the trailer control module in order to ensure reliable operation as intended.

The object of the present invention is to develop a trailer control module of the type mentioned at the beginning in an advantageous manner, in particular such that the trailer control module is constructed in a structurally simpler and less expensive way and is improved in respect of the control or regulating behavior and also has an increased functional density.

This object is achieved according to the invention by a trailer control module having the features of the independent claims. It is provided that a trailer control module for a brake device, in particular an electronic parking brake device, for a vehicle, in particular a commercial vehicle, having at least one control piston; and having at least one housing, in which the control piston is accommodated, is provided, wherein the housing has at least one control port and at least one feedback port for controlling the control piston, wherein the housing further has at least one supply port which is connected to at least one supply line for supplying the trailer control module with pressurized fluid, wherein the control piston is bistably activatable by the control port and by the feedback port.

The invention is based on the basic idea that the bistable behavior of the trailer control module is provided not by a brake device or parking brake device, as is conventional in the prior art, but by the trailer control module itself. This has the advantage that the trailer control module can be equipped with its own independent bistability, which was hitherto provided in a complex manner by the parking brake device and by way of the control line connected thereto. Switching of the different parking strategies of a trailer (braked or unbraked) having a coupled parking brake device has hitherto been possible by electronic control and then only with a considerable additional outlay with additional external components. As a result of an integrated bistability of the trailer control module, this electronic control can be implemented by means of a software function without additional outlay and in particular can be controlled or regulated independently of the parking brake device, resulting in considerable advantages as regards the functional configuration of the trailer control module. The provision of a feedback port additionally creates an improved and simplified structural and functional basis by which the bistability of the trailer control module can be implemented particularly advantageously, independently and precisely. It is contemplated here that the control port is connected to a first pressure chamber which is formed by a first pneumatic effective surface of the control piston and by the housing. It is additionally contemplated that the feedback port is connected to a second pressure chamber which is formed by a second effective surface of the control piston and by the housing. The resulting pressure force in the first pressure chamber, which acts on the first pneumatic effective surface, is opposed to a resulting pressure force in the second pressure chamber, which acts on the second pneumatic effective surface. In addition, the trend toward electrification is to be observed in the case of commercial vehicles, so that such vehicles will in future increasingly be driven electrically (directly electrically or by means of a fuel cell, for example) and accordingly will be braked purely electromechanically. For such vehicles, more specifically the towing vehicles, the pneumatic parking brake device is unnecessary. If, however, such a towing vehicle is to be paired with a conventional trailer having compressed air brakes, the towing vehicle can be equipped with the trailer control module according to the invention but no longer additionally with an electronic parking brake device, which leads to savings in terms of weight, costs and installation space. In summary, the trailer control module according to the invention can be provided in a towing vehicle of a commercial vehicle either with or without a parking brake device, wherein the parking brake device of the trailer is controllable or regulatable by the trailer control module according to the invention independently of the parking brake device of the towing vehicle.

In addition, it can be provided that the control port can be connected to at least a first control line, wherein the supply line has at least one supply line branch; wherein the control port can be connected to the supply line by way of the first control line and by way of the supply line branch. As a result of the connection of the first control line to the supply line, it is no longer necessary to provide an additional control line from an electronic parking brake to the trailer control module. This has the advantage that the length of the control line can be shortened considerably and thus the above-described problems from the prior art regarding the controllability or regulatability of the trailer control module and/or of the parking brake no longer arise. If a coupling with an electronic parking brake is provided, advantages are thus obtained in particular for the controllability of the trailer control module and of the parking brake of the trailer, since the control volume of the electronic parking brake is no longer negatively affected by variable lengths of the control lines to the trailer control valve. The control or regulating behavior of the electronic parking brake device thus improves and can consequently be coordinated or applied more easily and more precisely.

It is further contemplated that the first control line has at least a first control branch, wherein the feedback port can be connected to the first control branch by way of at least one feedback line. This type of pneumatic interconnection additionally offers a structurally simple and reliable way of connecting the control port and the feedback port to the same compressed air source, that is to say the supply line, and of connecting the control port to the feedback port. As a result, a structurally very simple and inexpensive construction is provided for the functionality of bistability. Moreover, this interconnection permits a short line length, so that rapid and precise activation of the control port and of the feedback port is thus possible.

It can be provided that the housing has a trailer control port for controlling a service brake of a trailer, said trailer control port being connected to a trailer control line. It is contemplated that the feedback port is formed substantially directly in and/or at the housing. In addition or alternatively, it is contemplated that the feedback port is configured as at least one trailer control line branch of the trailer control line or as the trailer control port. For example, this can mean that the feedback port is the trailer control port. In a sense, the trailer control port or the feedback port and/or the trailer control line can be able to be connected to the control port by way of the feedback line and the first control line.

It is additionally contemplated that at least one throttle is arranged in the first control line and/or in the feedback line. In particular, it can be provided that at least one throttle is arranged in the feedback line. A throttle allows the control port and/or the feedback port and thus also the first and second pressure chambers communicating therewith to be filled or pressurized at different speeds. Consequently, a bistable behavior of the control piston can be linked with a change in its switching position for activating the trailer brake. As a result, the trailer control module can be constructed in a structurally very simple manner, since a throttle represents a very reliable, fully developed and known way of controlling the pressure gradients at the control port or the feedback port.

In addition, it is possible that at least a first control valve, in particular a 2/2-way solenoid control valve, is arranged in the first control line. The control valve is configured in particular as a 2/2-way check valve, so that it forms a shut-off position and a passage position for the first control line. By shutting off and opening the first control line in a defined and clocked manner by the first control valve, the pressures at the control port and at the feedback port can be kept constant or changed in a predetermined or defined manner, so that the bistable behavior of the trailer control valve is improved by this first control valve and activation of the trailer brake can take place even more precisely. Moreover, a solenoid control valve is advantageous because it can be controlled quickly and precisely and independently of the pneumatic switching state of the parking brake, and a functional enhancement can thus easily be provided.

It can further be provided that the trailer control module has at least one control valve assembly or is coupled with at least one control valve assembly, wherein the control valve assembly can be connected to the first control line and/or to the feedback line. The control valve assembly is advantageous because, for example, the control port and the feedback port can be vented thereby in a precise and defined manner. By venting the control port and the feedback port, the pressures in the first and second pressure chambers can be lowered, so that, in response thereto, the chamber pressure in the second pressure chamber, for example, can be reduced and in turn can be outputted as a control pressure for the service brake of a trailer. In this respect, venting is essential for the precise and defined control of the trailer control module.

It is likewise contemplated that the control valve assembly has at least a second control valve and/or at least a third control valve. Dividing the control valve assembly into at least a second control valve and at least a third control valve has the advantage that these valves can be provided with different functions or function combinations, so that the range of functions and the controllability or regulatability of the trailer control module is increased.

It is additionally contemplated that the second control valve is configured as a pneumatically activated 2/2-way control valve and/or the third control valve is configured as a 2/2-way solenoid control valve. By means of such a control valve assembly, it becomes possible to provide a purely pneumatic backup control possibility, so that the operational reliability of the trailer control module and thus also of the commercial vehicle as a whole can be increased. In this connection, it is contemplated that the 2/2-way solenoid control valve is used for normal operation and thus the advantages thereof in respect of dynamic and precise control in the form of venting of the first control line and of the feedback line are utilized. In an undesirable operating state (if, for example, the first and/or third control valve fails), it is further possible to fall back on the second control valve as a fallback level, by means of which control continues to be possible as described above, so that the overall reliability of the trailer control module and of the vehicle is increased considerably.

It is further possible that the housing has at least one backup control port which can be connected to at least one control output of at least one footbrake module by way of at least one footbrake valve control line. By means of the backup control port, the overall reliability of the trailer control module and of the vehicle or commercial vehicle can be increased, since in the event of an undesirable operating state (if, for example, the first and/or third control valve fails or there is an electronic problem in the control unit for the activation thereof) of the trailer control module, pneumatic controllability that is independent of the electronic control continues to be ensured.

In addition, it can be provided that the second control valve has at least one pneumatic valve control port which can be connected by way of at least a second control line to the footbrake valve control line. The connection of the trailer control module to the footbrake module by way of the footbrake valve control line is advantageous in particular from the functional point of view. This is because the footbrake module already outputs a pneumatic control signal for actuation of the service brake, which signal, in addition to its actual use, can additionally be used in a particularly simple manner for the above-described backup case for activating the trailer control module.

It is further contemplated that the first control line has at least a second control branch which is arranged between the first control valve and the first control branch, wherein the control valve assembly can be connected to the second control branch by way of at least a second control line. This circuit structure offers the advantage that both the first control line and the feedback line can be activated simultaneously and jointly by the control valve assembly. In addition, the combination with the first and third control valves gives rise to additional and advantageous switching combinations (e.g. a trailer test state) which can be implemented very easily. For these reasons, fewer components are necessary for the activation thereof, so that the trailer control module can be configured to be smaller, more reliable, less expensive and with less installation space.

It is also contemplated that the second control valve is arranged in the feedback line. This circuit structure offers the advantage that, in the backup case, the feedback line can be shut off by the second control valve, so that the second pressure chamber in the trailer control module can no longer be activated. As a result, although the bistable behavior of the trailer control module is eliminated, that behavior is in any case not required in the backup case. Consequently, activation of the trailer control module in the backup case is simplified, which leads to an increase in the functional reliability of the trailer control module and of the commercial vehicle.

It can further be provided that the throttle is integrated in the second control valve. This configuration is very space-saving, since the throttle does not have to be arranged and fixed externally relative to the second control valve. In addition, the number of ports for connecting the throttle into the second control line is reduced.

The present invention relates additionally to a parking brake device, in particular an electronic parking brake device, for a vehicle, in particular a commercial vehicle, having at least one above-described trailer control module as claimed in one of the preceding claims. All the structural and functional features associated with the above-described trailer control module according to the invention and its possible embodiments can also be provided on their own or in combination in the parking brake device according to the invention and the advantages associated therewith can be achieved.

The present invention relates further to a commercial vehicle, in particular having at least one towing vehicle and having at least one trailer, having at least one above-described parking brake device and having at least one above-described trailer control module. All the structural and functional features associated with the above-described trailer control module according to the invention and the parking brake device and the possible embodiments can also be provided on their own or in combination in the commercial vehicle according to the invention and the advantages associated therewith can be achieved.

According to the present description, a line, for example any of the lines described herein, can be a duct and/or can be functionally designed as a duct.

Further details and advantages of the invention will now be explained in greater detail by means of the exemplary embodiments shown in the drawings.

### BRIEF DESCRIPTION OF THE DRAWINGS

FIG. 1 is a schematic representation of a first exemplary embodiment of a trailer control module according to the invention;

FIG. 2 is a schematic representation of the first exemplary embodiment of the trailer control module according to FIG. 1;

FIG. 3 is a further schematic representation of the first exemplary embodiment of the trailer control module according to FIG. 1;

FIG. 4 is a schematic representation of a second exemplary embodiment of a trailer control module;

FIG. 5 is a schematic representation of a third exemplary embodiment of a trailer control module;

FIG. 6 is a schematic representation of a fourth exemplary embodiment of a trailer control module;

FIG. 7 is a schematic representation of the fourth exemplary embodiment of the trailer control module according to FIG. 6;

FIG. 8 is a schematic representation of a fifth exemplary embodiment of a trailer control module; and

FIG. 9 is a schematic representation of a sixth exemplary embodiment of a trailer control module according to the invention.

### DETAILED DESCRIPTION OF THE DRAWINGS

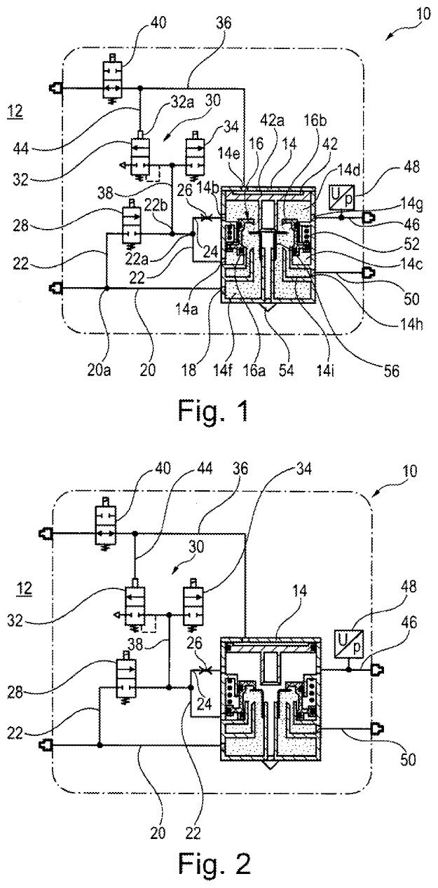

FIG. 1 shows a schematic representation of a first exemplary embodiment of a trailer control module 10 according to the invention for an electronic parking brake device 12 of a commercial vehicle.

The trailer control module 10 has a housing 14, wherein a control piston 16 is accommodated in the housing 14.

The housing 14 has a supply port 18 which is connected to a supply line 20 for supplying the trailer control module 10 with pressurized fluid in the form of compressed air.

The supply line 20 can either be connected to a supply line of a brake device or of a parking brake device of a commercial vehicle or directly to a port of a multi-circuit protection valve.

The supply line 20 has a supply line branch 20a.

The housing 14 further has a control port 14a which can be connected to a first control line 22 for controlling the control piston 16.

According to FIG. 1, the control port 14a can be connected by way of the first control line 22 and by way of the supply line branch 20a to the supply line 20.

Consequently, the first control line 22 extends, starting from the supply line branch 20a, parallel to the supply line 20.

The housing 14 further has a feedback port 14b for controlling the control piston 16.

According to FIG. 1, the control port 14a is connected to a first pressure chamber 14c, which in the mounted state is formed at least in part by a first pneumatic effective surface 16a of the control piston 16 and by a housing shoulder of the housing 14.

Correspondingly, the feedback port 14b is connected to a second pressure chamber 14d, which in the mounted state is formed at least in part by a second pneumatic effective surface 16b of the control piston 16 and by a further housing shoulder of the housing 14.

The first control line 22 further has a first control branch 22a.

The feedback port 14b can be connected to the first control branch 22a by way of a feedback line 24.

Thus, the feedback line 24 extends, starting from the first control branch 22a, parallel to the first control line 22.

A throttle 26 is arranged in the feedback line 24.

In addition or alternatively, it can be provided that a further throttle is arranged in the first control line 22.

A first control valve 28 is further arranged in the first control line 22.

The first control valve 28 is configured as a 2/2-way solenoid control valve and has a shut-off position and a passage position, wherein the first control valve 28 is in the shut-off position in its deenergized state.

The trailer control module 10 further has a control valve assembly 30.

In addition or alternatively, it can be provided that the trailer control module 10 is coupled with, or can be connected to, the control valve assembly 30.

According to FIG. 1, the control valve assembly 30 is connected to the first control line 22.

In addition or alternatively, it can be provided that the control valve assembly 30 can be connected to the feedback line 24.

The control valve assembly 30 has a second control valve 32 and a third control valve 34.

The second control valve 32 is configured as a pneumatically activated 2/2-way control valve and has a shut-off position and a vent position, wherein the second control valve 32 is in the shut-off position in the state in which it is free of control pressure.

The third control valve 34 is in turn configured as a 2/2-way solenoid control valve and also has a shut-off position and a vent position, wherein the third control valve 34 is likewise in the shut-off position in the deenergized state.

The housing 14 further has a backup control port 14e which can be connected to a control output of a footbrake module (not shown) by way of a footbrake valve control line 36.

The footbrake valve control line 36 is connected by way of a backup control line 44 to the second control valve 32 by way of a pneumatic valve control port 32a of the second control valve 32.

A fourth control valve 40 in the form of a 2/2-way solenoid control valve is arranged in the footbrake valve control line 36.

The fourth control valve 40 has a shut-off position and a passage position, wherein the fourth control valve 40 is in the shut-off position in the deenergized state (however, in FIG. 1 it is shown reversed, wherein the fourth control valve 40 is shown in the passage position in the deenergized state).

In the housing 14 there is further accommodated a backup control piston 42, the pneumatic effective surface 42a of which, together with the housing, forms a third pressure chamber 14f.

The first control line 22 further has a second control branch 22b which is arranged between the first control valve 28 and the first control branch 22a.

The control valve assembly 30 according to FIG. 1 is connected to the second control branch 22b by way of a corresponding second control line 38.

According to FIG. 1, the trailer control module 10 further has a trailer control port 14g for the service brake of a trailer (not shown in FIG. 1), said trailer control port opening into the second pressure chamber 14d and further being connected to a corresponding trailer control line 46.

In a sense, the feedback port 14b is connected by way of the second pressure chamber 14d to the trailer control port 14g and thus to the trailer control line 46.

A pressure sensor 48 is additionally arranged in this trailer control line 46.

According to FIG. 1, the trailer control module 10 further has a trailer supply port 14h for supplying the trailer with compressed air, said trailer control port opening into a fourth pressure chamber 14i of the housing 14 and further being connected to a corresponding trailer supply line 50.

At the base of the housing 14 there is additionally arranged a vent 54 which is connected to a central vent channel which extends axially from the base approximately half way into the housing 14, where it forms a free end.

In the region of the free end, a guide or sealing sleeve 56 is arranged in an axially displaceable manner on the vent channel and forms a first seal seat with the valve piston 16 in the closed position thereof (when the first and second control ports 14a, 14b are vented).

The guide or sealing sleeve 56 can further form a further seal seat with a housing projection or housing shoulder arranged therebeneath in the mounted state.

According to FIG. 1, the trailer control module 10 structurally forms the system boundary shown by the dot-and-dash line, so that, according to a first exemplary embodiment, all the above-mentioned pneumatic structural elements such as the housing, the valves, lines, ports, branches, etc. which are shown in FIG. 1 can form, individually or in combination, a structural unit in the form of the trailer control module 10.

The further ports shown at the system boundary are to be understood as being by way of example, so that one or more of these ports can alternatively also have a different position outside or inside the system boundary.

The present invention relates additionally to an electronic parking brake device 12 for a commercial vehicle having the above-described trailer control module 10.

All the structural and functional features associated with the above-described trailer control module 10 according to the invention and its possible embodiments can also be provided on their own or in combination in the parking brake device 12 according to the invention and the advantages associated therewith can be achieved.

The present invention relates further to a commercial vehicle having a towing vehicle and having at least one trailer and also having the above-described parking brake device and having an above-described trailer control module 10.

All the structural and functional features associated with the above-described trailer control module 10 according to the invention and with the parking brake device 12 and the possible embodiments can also be provided on their own or in combination in the commercial vehicle according to the invention and the advantages associated therewith can be achieved.

The function of the trailer control module 10 will now be described as follows.

FIG. 1 shows a switching state of the trailer control module 10 that corresponds to a parked state of the commercial vehicle at a standstill with the trailer braked.

In the braked state, the maximum possible control pressure of about 8.5 bar which can be outputted is present at the trailer control line 46, by means of which pressure the service brakes of the trailer can be activated and, when the commercial vehicle is stationary, can function as parking brakes, wherein spring brake cylinders are also contemplated in addition or alternatively.

In order to achieve this state, the first control valve 28 is opened by a control or regulating device (not shown in FIG. 1) connected thereto until the maximum control pressure is present at the control port 14a and the feedback port 14b.

The control piston 16 is thus bistably activatable by the control port 14a and by the feedback port 14b.

As a result, the control piston 16 is in its maximum open position, so that the supply port 18 is connected by way of the second pressure chamber 14d to the trailer control port 14g and the brake cylinders of the trailer are activated with maximum control pressure, which corresponds to a maximum braking action.

As soon as the maximum control pressure is present, the first control valve 28 is closed again, wherein the control valve assembly 30, that is to say the second and third control valves 32, 34, each remain in the shut-off position during the pressure build-up.

The pressure forces in opposite directions resulting from the pressures in the first and second pressure chambers 14c, 14d and the force of the piston spring 52 form a force equilibrium, so that the control piston 16 is at rest at maximum pressure.

That the control piston 16 is movable from this equilibrium into other stable switching positions is due in particular also to the throttle 26, which is arranged in the feedback line 24.

Because the same control pressure is applied to the first control line 22 and the feedback line 24, the first and second control chambers 14c, 14d are pressurized by way of the control port 14a and the feedback port 14b on pressurization.

However, because a throttle 26 is arranged in the feedback line 24, the first control line 22 has a greater pressure gradient than the second control line 24.

Because the control pressure is consequently built up more quickly in the first pressure chamber 14c than in the second pressure chamber 14d, the control piston 16 is initially able to move within a given period of time (e.g. as long as the first control valve 28 is open) axially in the direction of the second pressure chamber 14d, until the corresponding control pressure has also built up there in a delayed manner and generates a corresponding counter-force, so that the control piston 16 then comes to a stop and assumes a stable position.

For venting by the third control valve 34 (in normal operation), the procedure described above applies in the reverse order, wherein a corresponding switching position of the control piston is shown in FIG. 2.

FIG. 2 shows a further schematic representation of the first exemplary embodiment of the trailer control module 10 according to the invention according to FIG. 1.

In FIG. 2, the trailer control module 10 is in its vented state, in respect of which the control port 14a and the feedback port 14b have previously been vented to atmospheric pressure or close to atmospheric pressure by way of the third control valve 34.

The vented state is recognizable by the position of the control piston 16, which is in its lowermost position and, together with the sealing sleeve 56, forms the corresponding vent valve seat.

It can additionally be seen in FIG. 2 that the control piston 16 has displaced the sealing sleeve 56 axially in the vent position, so that the trailer control line 46 is connected by way of the second pressure chamber 14d to the vent 54 (see also FIG. 1).

However, the position of the control piston 16 and the sealing sleeve 56 continues to permit the connection between the supply port 18 of the trailer control module 10 and the trailer supply port 14h, so that, for example, a compressed air reservoir of the trailer or another consumer can continue to be supplied with compressed air.

The piston position shown in FIG. 2 corresponds on the one hand to the moved state of the commercial vehicle (that is to say its driving state), since no control pressure is present at the trailer control line 46 and thus the brakes of the trailer are not actuated and consequently no braking action is achieved.

Alternatively, the piston position shown in FIG. 2 can also correspond to a parked state of the commercial vehicle (that is to say at a standstill), if the so-called trailer test is carried out.

The switching positions described in connection with FIGS. 1 and 2 of the control piston 16 represent, in intended or normal states, the two switching position limit states, in respect of which on the one hand the maximum braking action is achievable (see FIG. 1) or no braking action is achievable (see FIG. 2).

By introducing air into or venting the control port 14a and the feedback port 14b (by activation of the first or third control valve 28, 34) in a correspondingly clocked manner (that is to say according to a defined period of time), defined intermediate positions of the control piston 16 between these two limit states can additionally be outputted, so that the normal service brake control of the trailer is thus controlled during the driving state.

The bistability of the control piston 16 is achieved in that the brake pressure at the trailer can also be conveyed by way of the feedback line 24 to the control line 22, as a result of which the control pressure can fall or rise depending on whether the control pressure or the brake pressure is or becomes higher.

If the pressure is not regulated by the valves, the pressure can increase further and further and the control piston 16 moves into the switching position that corresponds to a parked state (see FIG. 1), or the pressure can fall and the control piston 16 moves into the switching position that corresponds to a driving state (see FIG. 2).

As is shown in FIG. 1, when the vehicle is parked, the first pressure chamber 14c is connected by way of the feedback line 24 and the second pressure chamber 14d to the third pressure chamber 14f. If air is lost from the first pressure chamber 14c or the associated control line 22, further air is supplied via this connection or this path. The control pressure at the control piston 16 is thus maintained and the control piston 16 remains stably in the switching position that corresponds to a parked state.

As is shown in FIG. 2, when the vehicle is driving, the first pressure chamber 14c is connected by way of the feedback line 24 to the second pressure chamber 14d and thus to the vent 54. If a leak occurs and air flows into the first pressure chamber 14c or into the associated control line 22, then the air can be removed (i.e. is removable) by way of this connection or this path and the vehicle can safely remain in the driving state, or the control piston 16 remains stably in the switching position that corresponds to a driving state.

Consequently, the switching positions described in connection with FIGS. 1 and 2 can define two stable states of the control piston 16; that is to say, in other words, bistability.

Consequently, the control piston 16 is bistably activatable by the control port 14a and by the feedback port 14b.

Referring to FIG. 1 and FIG. 2, it is also contemplated, in addition or alternatively, that at least one connection, for example line, integrated in the housing 14 can be provided, which connects the first pressure chamber 14c and the second pressure chamber 14d together.

In a sense, the feedback line 24 can in this case be configured as an integrated line in the housing 14. Accordingly, the respective (integrated) openings thereof into or at the first pressure chamber 14c and the second pressure chamber 14d can be understood as being a control port, for example the control port 14a, and a feedback port, for example the feedback port 14b.

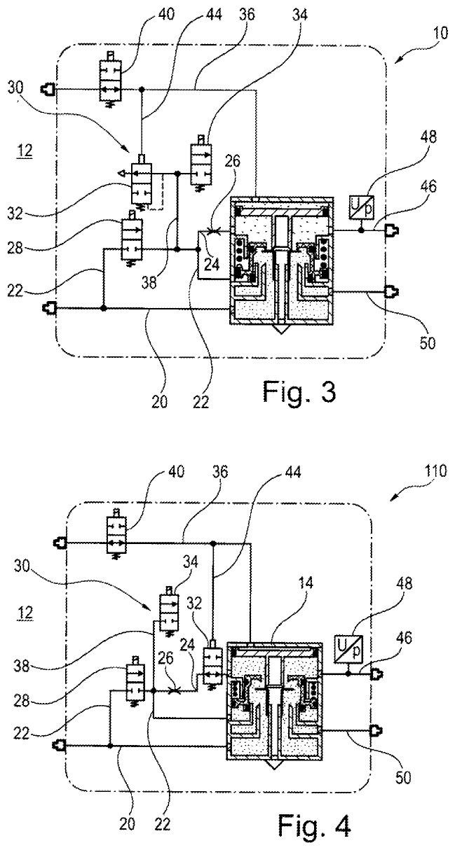

FIG. 3 shows a further schematic representation of the first exemplary embodiment of the trailer control module 10 according to the invention according to FIG. 1.

FIG. 3 shows the backup case, that is to say a defect or failure has occurred in one of the control valves 28, 32, 34 and/or in the control or regulating unit for activation thereof.

In this case, the fourth control valve 40 moves into the switching position shown according to FIGS. 1 to 3, so that the footbrake valve control line 36 is pressurized, which results in pressurization of the pneumatic control input 32a of the second control valve 32 and of the backup control port 14e of the housing 14.

In response, the second control valve 32 moves into the passage position shown in FIG. 3, so that the control port 14a and the feedback port 14b are vented and the control piston 16 moves into the lowermost position and closes the valve seat with the vent sleeve 56.

In addition, pressurization of the backup control port 14e has the result that the backup piston 42 then moves into the position shown in FIG. 3 and, as it moves further, opens the valve seat by the vent sleeve 56 and the control piston 16.

This opening has the result that the supply port 18 can again be connected to the trailer control line 46, which in the backup case leads to reliable and purely pneumatic braking of the trailer, in the manner already described above.

In order to lessen the braking effect, the trailer control line 46 must be vented, which occurs in that the backup piston 42 moves into its uppermost position and the switching position shown according to FIG. 2 can thus be applied to the backup case.

FIG. 4 shows a schematic representation of a second exemplary embodiment of a trailer control module 10 according to the invention.

The second exemplary embodiment of the trailer control module 110 according to the invention shown in FIG. 4 has substantially the same structural and functional features as the first exemplary embodiment of the trailer control module 10 according to the invention shown in FIGS. 1 to 3.

Only the following structural and functional feature differences are to be highlighted:

According to FIG. 4, the second control valve 32 is arranged in the feedback line 24.

The second control valve 32 is further arranged in the feedback line 24 between the throttle 26 and the feedback port 14b.

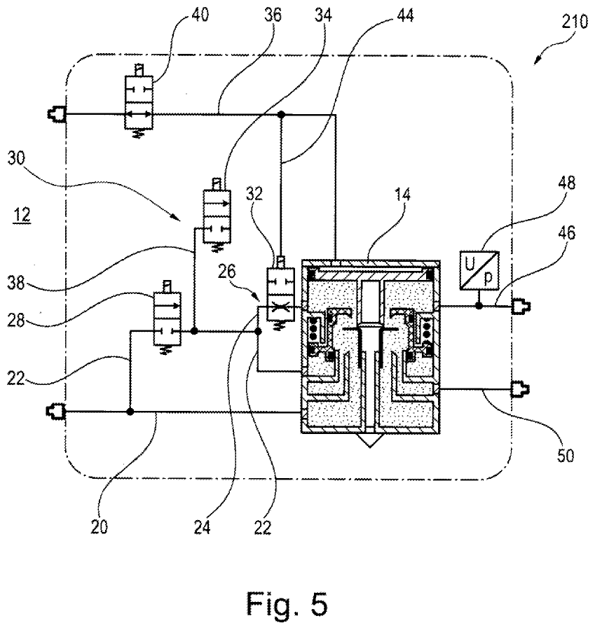

FIG. 5 shows a schematic representation of a third exemplary embodiment of a trailer control module 210 according to the invention.

The third exemplary embodiment of the trailer control module 210 according to the invention shown in FIG. 5 has substantially the same structural and functional features as the second exemplary embodiment of the trailer control module 110 shown in FIG. 4.

Only the following structural and functional feature differences are to be highlighted:

The throttle 26 is integrated in the second control valve 32, so that a more compact and more efficient valve device is formed and the throttling action can be shut off.

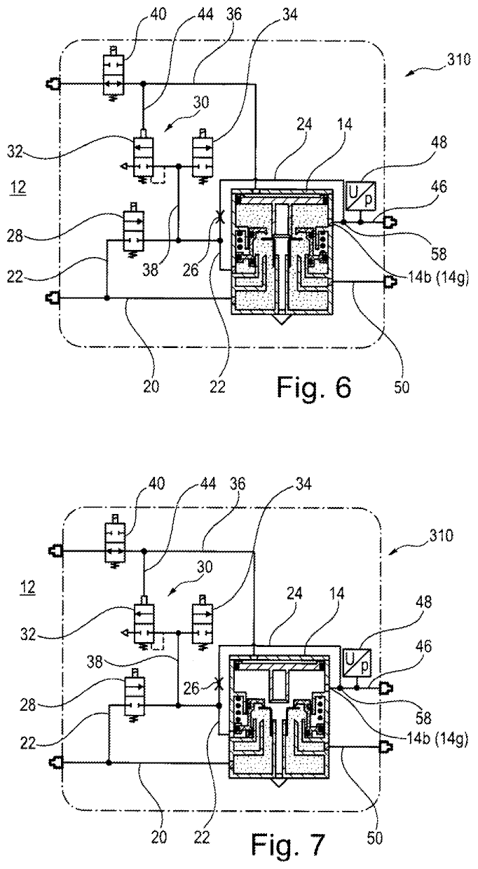

FIG. 6 and FIG. 7 show a schematic representation of a fourth exemplary embodiment of a trailer control module 310 according to the invention.

The fourth exemplary embodiment of the trailer control module 310 according to the invention shown in FIGS. 6 and 7 has substantially the same structural and functional features as the first exemplary embodiment of the trailer control module 10 shown in FIGS. 1 and 2.

Furthermore, FIG. 6 shows the stable state of bistability that is shown in respect of the first exemplary embodiment of the trailer control module 10 in FIG. 1, and FIG. 7 shows the stable state of bistability that is shown in respect of the first exemplary embodiment of the trailer control module 10 in FIG. 2.

Only the structural and functional feature differences are to be highlighted below.

The feedback port 14b is configured as the trailer control port 14g. In a sense, the feedback port 14b forms the trailer control port 14g. In other words, the feedback port 14c further functions as the trailer control port 14g.

The trailer control line 46, which is connected to the feedback port 14b functioning as the trailer control port 14g, has a trailer control line branch 58 to which the feedback line 24 is connected.

The feedback port 14b can consequently be connected by way of the trailer control line branch 58 and the feedback line 24 to the first control branch 22a.

In addition or alternatively, it is also contemplated that the feedback port 14b is configured as the trailer control line branch 58.

In addition or alternatively, it is also contemplated that the feedback line 24 is connected to the feedback port 14b and has the trailer control line branch 58 to which the trailer control line 46 can be connected or is connected.

Compared to the first exemplary embodiment, the feedback line 24 is no longer connected to the second pressure chamber 14d but is connected to the trailer control line 46. In a sense, however, the feedback line 24 is still connected to the second pressure chamber 14d by way of the trailer control line 46.

The brake pressure at the trailer can also be conveyed by way of the feedback line 24 to the control line 22, as a result of which the control pressure can fall or rise depending on whether the control pressure or the brake pressure is or becomes higher.

If the pressure is not regulated by the valves, the pressure can increase further and further and the control piston 16 moves into the switching position that corresponds to a parked state (see FIG. 6), or the pressure can fall and the control piston 16 moves into the switching position that corresponds to a driving state (see FIG. 7).

As is shown in FIG. 6, when the vehicle is parked, the first pressure chamber 14c is connected by way of the feedback line 24 and the second pressure chamber 14d to the third pressure chamber 14f. If air is lost from the first pressure chamber 14c or the associated control line 22, further air is supplied by way of this connection or this path. As a result, the control pressure at the control piston 16 is maintained and the control piston 16 remains stably in the switching position that corresponds to a parked state.

As is shown in FIG. 7, when the vehicle is driving, the first pressure chamber 14c is connected by way of the feedback line 24 to the second pressure chamber 14d and thus to the vent 54. If a leak occurs and air flows into the first pressure chamber 14c or into the associated control line 22, then the air can be removed (i.e. is removable) by way of this connection or this path and the vehicle can safely remain in the driving state, or the control piston 16 remains stably in the switching position that corresponds to a driving state.

Consequently, the switching positions described in connection with FIGS. 6 and 7 can define two stable states of the control piston 16; that is to say, in other words, bistability.

Consequently, the control piston 16 is bistably activatable by the control port 14a and by the feedback port 14b.

In a sense, the control piston 16 is bistably activatable by the control port 14a by way of the feedback port 14b, in particular by way of the feedback port 14b and the feedback line 24.

Referring to FIGS. 6 and 7, it is also contemplated, in addition or alternatively, that at least one connection, for example line, integrated in the housing 14 can be provided, which connects the first pressure chamber 14c and the second pressure chamber 14d together.

In a sense, the feedback line 24 can in this case be configured as an integrated line in the housing 14. Accordingly, the respective (integrated) openings thereof into or at the first pressure chamber 14c and the second pressure chamber 14d can be understood as being a control port, for example the control port 14a, and a feedback port, for example the feedback port 14b.

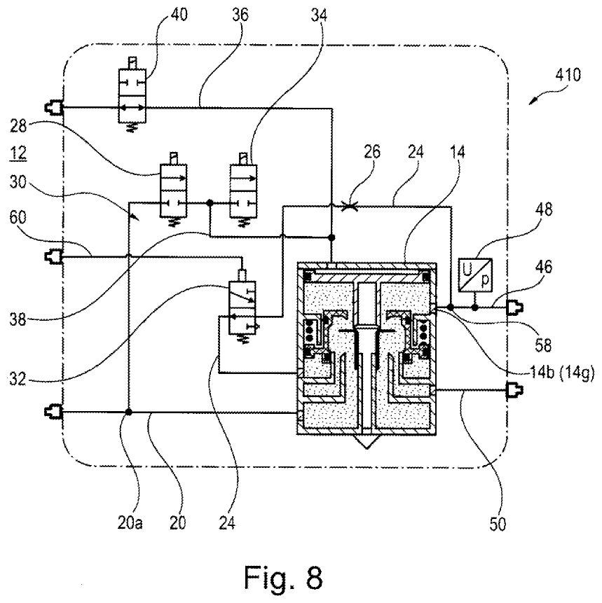

FIG. 8 shows a schematic representation of a fifth exemplary embodiment of a trailer control module 410 according to the invention.

The fifth exemplary embodiment of the trailer control module 410 according to the invention shown in FIG. 8 has substantially the same structural and functional features as the exemplary embodiment of the trailer control module 310 according to the invention shown in FIGS. 6 and 7.

Only the following structural and functional feature differences are to be highlighted:

The trailer control line 46, which is connected to the feedback port 14b functioning as the trailer control port 14g, likewise has the trailer control line branch 58 to which the feedback line 24 is connected.

This feedback line 24 is connected to the first control port 14a, wherein the second control valve 32 is arranged in the feedback line 24.

In a sense, the part of the feedback line 24 that is arranged between the second control valve 32 and the first control port 14a functions as a or the control line 22.

The feedback port 14b can consequently be connected by way of the trailer control line branch 58 and the feedback line 24 via the second control valve 32 to the first control port 14a.

In addition or alternatively, it is also contemplated that the feedback port 14b is configured as the trailer control line branch 58.

In addition or alternatively, it is also contemplated that the feedback line 24 is connected to the feedback port 14b and has the trailer control line branch 58 to which the trailer control line 46 can be connected or is connected.

The second control valve 32 arranged in the feedback line 24 is here configured as a pneumatically activated 3/2-way control valve and has a passage position and a vent position, wherein the second control valve 32 is in the passage position in the state in which it is free of control pressure.

The second control valve 32 is connected by way of a PPB/EPB line 60 (i.e. a pneumatic parking brake/electronic parking brake line 60) to a PPB/EPB port (i.e. a pneumatic parking brake/electronic parking brake port by way of which, for example, a corresponding parking brake actuation can be conveyed) of the parking brake device 12 and is pneumatically activatable by way of this PPB/EPB line 60.

In the passage position of the second control valve 32 (see FIG. 8), the first control port 14a can be connected or is connected to the trailer control line 46 via the feedback line 24 and thus also the first pressure chamber 14c.

In the vent position of the second control valve 32, the feedback line 24 is interrupted by the switching position of the second control valve 32 and the first control port 14a can be vented or is vented and thus the first pressure chamber 14c (in each case via the part of the feedback line 24 that is arranged between the second control valve 32 and the first control port 14a).

As a result of the above-described arrangement of the feedback line 24, the brake pressure at the trailer can thus be conveyed by way of this feedback line 24 to the first control port 14a, as a result of which the control pressure can fall or rise depending on whether the control pressure or the brake pressure is or becomes higher.

The first control port 14a can additionally be vented by the second control valve 32 (in the vent position).

Furthermore, the footbrake valve control line 36, which is connected to the backup control port 14e of the housing 14, is connected to the first control valve 28 and the third control valve 34 by means of a branch.

The first control valve 28 is configured as a 2/2-way solenoid control valve and has a shut-off position and a passage position, wherein the first control valve 28 is in its shut-off position in the deenergized state.

The first control valve 28 is further connected (in terms of line technology) to the supply line branch 20a.

The supply line branch 20a can thus be connected or is connected (in the passage position) by way of the first control valve 28 to the footbrake valve control line 36.

The third control valve 34 is configured as a 2/2-way solenoid control valve and has a shut-off position and a vent position, wherein the third control valve is likewise in the shut-off position in the deenergized state.

With reference to the bistability, FIG. 8 shows the stable state of bistability, which is shown in respect of the fourth exemplary embodiment of the trailer control module 310 in FIG. 6.

If the pressure is not regulated by the valves, the pressure can rise further and further and the control piston 16 moves into the switching position that corresponds to a parked state (see FIG. 8), or the pressure can fall and the control piston 16 moves into the switching position that corresponds to a driving state (not shown in the figures).

As is shown in FIG. 8, when the vehicle is parked, the first pressure chamber 14c is connected by way of the feedback line 24 and the second pressure chamber 14d to the third pressure chamber 14f. If air is lost from the first pressure chamber 14c, further air is supplied via this connection or this path. As a result, the control pressure at the control piston 16 is maintained and the control piston 16 remains stably in the switching position that corresponds to a parked state.

When the vehicle is driving (not shown in the figures), the first pressure chamber 14c is connected by way of the feedback line 24 and the second control valve 32 (in the vent position) to the vent. If a leak occurs and air flows into the first pressure chamber 14c, then the air can be removed (i.e. is removable) by way of this connection or this path and the vehicle can safely remain in the driving state, or the control piston 16 remains stably in the switching position that corresponds to a driving state.

Consequently, two stable states of the control piston 16 can be defined; that is to say, in other words, bistability.

Consequently, the control piston 16 is bistably activatable by the control port 14a and by the feedback port 14b.

In a sense, the control piston 16 is bistably activatable by the control port 14a by way of the feedback port 14b, in particular by way of the feedback port 14b and the feedback line 24.

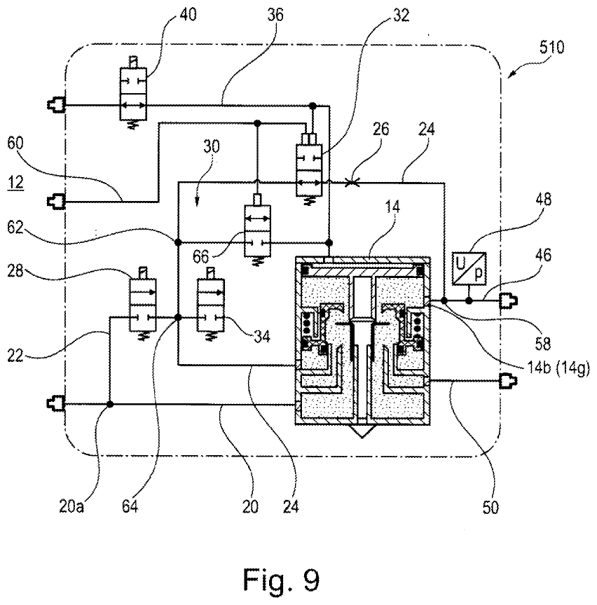

FIG. 9 shows a schematic representation of a sixth exemplary embodiment of a trailer control module 510 according to the invention.

The sixth exemplary embodiment of the trailer control module 510 according to the invention shown in FIG. 9 has substantially the same structural and functional features as the exemplary embodiment of the trailer control module 410 according to the invention shown in FIG. 8.

Only the following structural and functional feature differences are to be highlighted.

The trailer control line 46, which is connected to the feedback port 14b functioning as the trailer control port 14g, likewise has the trailer control line branch 58, to which the feedback line 24 is connected.

This feedback line 24 is connected to the first control port 14a, wherein the second control valve 32 is arranged in the feedback line 24.

In a sense, the part of the feedback line 24 that is arranged between the second control valve 32 and the first control port 14a functions as a or the control line 22.

The feedback port 14b can consequently be connected by way of the trailer control line branch 58 and the feedback line 24 via the second control valve 32 to the first control port 14a.

In addition or alternatively, it is also contemplated that the feedback port 14b is configured as the trailer control line branch 58.

In addition or alternatively, it is also contemplated that the feedback line 24 is connected to the feedback port 14b and has the trailer control line branch 58 to which the trailer control line 46 can be connected or is connected.

The second control valve 32 arranged in the feedback line 24 is here configured as a pneumatically activated 2/2-way control valve and has a passage position and a shut-off position, wherein the second control valve 32 is in the passage position in the state in which it is free of control pressure.

The second control valve 32 is connected by way of the PPB/EPB line 60 (i.e. the pneumatic parking brake/electronic parking brake line 60) to the PPB/EPB port (i.e. the pneumatic parking brake/electronic parking brake port by way of which, for example, a corresponding parking brake actuation can be conveyed) of the parking brake device 12 and is pneumatically activatable by way of this PPB/EPB line 60.

The second control valve 32 is further connected to the footbrake valve control line 36 and is further also pneumatically activatable by way of this footbrake valve control line 36.

In the passage position of the second control valve 32 (see FIG. 9), the first control port 14a can be connected or is connected to the trailer control line 46 via the feedback line 24 and thus also the first pressure chamber 14c.

In the shut-off position of the second control valve 32, the feedback line 24 is interrupted by the switching position of the second control valve 32.

The feedback line 24 further has a first branch 62 and a second branch 64, which are arranged between the second control valve 32 and the control port 14a.

A connecting line connects the first branch 62 of the feedback line 24 to the footbrake valve control line 36, wherein a fifth control valve 66 is arranged in this connecting line.

The fifth control valve 66 arranged in the connecting line is here configured as a pneumatically activated 2/2-way control valve and has a passage position and a shut-off position, wherein the fifth control valve 66 is in the shut-off position in the state in which it is free of control pressure.

The fifth control valve 66 is connected by way of the PPB/EPB line 60 to the PPB/EPB port of the parking brake device 12 and is pneumatically activatable by way of this PPB/EPB line 60.

In the passage position of the fifth control valve 66, the first control port 14a can be connected or is connected to the footbrake valve control line 36 via the feedback line 24, in particular a sub-portion of the feedback line 24.

In the shut-off position of the fifth control valve 66 (see FIG. 9), the feedback line 24 has been/is separated from the footbrake valve control line 36 by the switching position of the fifth control valve 66, or said connecting line has been/is interrupted.

Because the second control valve 32 is in the passage position in the state in which it is free of control pressure and the fifth control valve 66 is in the shut-off position in the state in which it is free of control pressure, the two control valves 32, 66 can only ever be in opposite switching positions by means of (e.g. sole) activation by way of the PPB/EPB line 60.

As a result of the above-described arrangement of the feedback line 24, the brake pressure at the trailer can thus be conveyed by way of this feedback line 24 to the first control port 14a, as a result of which the control pressure can fall or rise depending on whether the control pressure or the brake pressure is or becomes higher.

Furthermore, the first control valve 28 and the third control valve 34 are connected to the feedback line 24 by means of the second branch 64 of the feedback line 24.

The footbrake valve control line 36, which is connected to the backup control port 14e of the housing 14, can thus be connected or is connected via the fifth control valve 66 and the first and the second branches 62, 64 of the feedback line 24 to the first control valve 28 and the third control valve 34 (when control pressure is applied to the fifth control valve 66 by way of the PPB/EPB line 60).

The first valve 28 is configured as a 2/2-way solenoid control valve and has a shut-off position and a passage position, wherein the first control valve 28 is in the shut-off position in its deenergized state.

The first control valve 28 is further connected (in terms of line technology) to the supply line branch 20a.

The supply line branch 20a can thus be connected or is connected (in the passage position) by way of the first control valve 28 and the fifth control valve 66 to the footbrake valve control line 36.

The third control valve 34 is configured as a 2/2-way solenoid control valve and has a shut-off position and a vent position, wherein the third control valve 34 is likewise in the shut-off position in the deenergized state.

With reference to the bistability, FIG. 9 shows the stable state of bistability, which is shown in respect of the fourth exemplary embodiment of the trailer control module 310 in FIG. 6 (and which is shown in respect of the fifth exemplary embodiment of the trailer control module 410 in FIG. 8).

If the pressure is not regulated by the valves, the pressure can rise further and further and the control piston 16 moves into the switching position that corresponds to a parked state (see FIG. 9), or the pressure can fall and the control piston 16 moves into the switching position that corresponds to a driving state (not shown in the figures).

As is shown in FIG. 9, when the vehicle is parked, the first pressure chamber 14c is connected by way of the feedback line 24 and the second pressure chamber 14d to the third pressure chamber 14f. If air is lost from the first pressure chamber 14c, further air is supplied via this connection or this path. As a result, the control pressure at the control piston 16 is maintained and the control piston 16 remains stably in the switching position that corresponds to a parked state.

When the vehicle is driving (not shown in the figures), the first pressure chamber 14c is connected by way of the feedback line 24 to the second pressure chamber 14d and thus to the vent 54. If a leak occurs and air flows into the first pressure chamber 14c, then the air can be removed (i.e. is removable) by way of this connection or this path and the vehicle can safely remain in the driving state, or the control piston 16 remains stably in the switching position that corresponds to a driving state.

Consequently, two stable states of the control piston 16 can be defined. These two states define the bistability.

Consequently, the control piston 16 is bistably activatable by the control port 14a and by the feedback port 14b.

In a sense, the control piston 16 is bistably activatable by the control port 14a by way of the feedback port 14b, in particular by way of the feedback port 14b and the feedback line 24.

### LIST OF REFERENCE SIGNS

10 trailer control module
12 parking brake device
14 housing
14a first control port
14b feedback port
14c first pressure chamber
14d second pressure chamber
14e backup control port
14f third pressure chamber
14g trailer control port
14h trailer supply port
14i fourth pressure chamber
16 control piston
16a first pneumatic effective surface
16b second pneumatic effective surface
18 supply port
20 supply line
20a supply line branch
22 first control line
22a first control branch
22b second control branch
24 feedback line
26 throttle
28 first control valve
30 control valve assembly
32 second control valve
32a pneumatic valve control port
34 third control valve
36 footbrake valve control line
38 second control line
40 fourth control valve
42 backup control piston
42a pneumatic effective surface of the backup control piston
44 backup control line
46 trailer control line
48 pressure sensor
50 trailer supply line
52 piston spring
54 vent
56 guide or sealing sleeve
58 trailer control line branch
60 PPB/EPB line
62 first branch of the feedback line
64 second branch of the feedback line
66 fifth control valve
110 trailer control module
210 trailer control module
310 trailer control module
410 trailer control module
510 trailer control module

1.-15. (canceled)

16. A trailer control module for a brake device for a vehicle, comprising:
at least one control piston; and
at least one housing in which the control piston is accommodated, wherein
the housing has at least one control port and at least one feedback port for controlling the control piston,
the housing further has at least one supply port which is connected to at least one supply line for supplying the trailer control module with pressurized fluid, and
the control piston is bistably activatable by the control port and by the feedback port.

17. The trailer control module as claimed in claim 16, wherein
the control port is connectable to at least a first control line,
the supply line has at least one supply line branch,
the control port is connectable to the supply line by way of the first control line and by way of the supply line branch.

18. The trailer control module as claimed in claim 17, wherein
the first control line has at least a first control branch,
the feedback port is connectable to the first control branch by way of at least one feedback line.

19. The trailer control module as claimed in claim 16, wherein
at least one throttle is arranged in the first control line and/or in a feedback line.

20. The trailer control module as claimed in claim 16, wherein
at least a first control valve is arranged in the first control line.

21. The trailer control module as claimed in claim 20, wherein
the first control valve is a 2/2-way solenoid control valve.

22. The trailer control module as claimed in claim 16, further comprising:
at least one control valve assembly that is coupled with, or included as part of, the trailer control module,
wherein the control valve assembly is connectable to the first control line and/or to a feedback line.

23. The trailer control module as claimed in claim 22, wherein
the control valve assembly has at least a second control valve and/or at least a third control valve.

24. The trailer control module as claimed in claim 23, wherein
the second control valve is configured as a pneumatically activated 2/2-way control valve and/or the third control valve is configured as a 2/2-way solenoid control valve.

25. The trailer control module as claimed in claim 16, wherein
the housing has at least one backup control port which is connectable to at least one control output of at least one footbrake module by way of at least one footbrake valve control line.

26. The trailer control module as claimed in claim 25, wherein
the second control valve has at least one pneumatic valve control port which is connectable by way of at least one backup control line to the footbrake valve control line.

27. The trailer control module as claimed in claim 20, wherein
the first control line has at least a second control branch which is arranged between the first control valve and the first control branch,
the control valve assembly is connectable to the second control branch by way of at least a second control line.

28. The trailer control module as claimed in claim 23, wherein
the second control valve is arranged in the feedback line.

29. The trailer control module as claimed in claim 28, wherein
a throttle is integrated in the second control valve.

30. A parking brake device for a vehicle comprising at least one trailer control module as claimed in claim 16.

31. A commercial vehicle, comprising:
at least one towing vehicle and at least one trailer; and
at least one parking brake device as claimed in claim 30.
